(19) United States
(12) Patent Application Publication
(10) Pub. No.: US 2021/0078102 A1
(43) Pub. Date: Mar. 18, 2021

(54) COATING METHOD AND COATING STRUCTURE

(71) Applicant: KABUSHIKI KAISHA TOSHIBA, Minato-ku (JP)

(72) Inventors: Yasutomo SHIOMI, Koza (JP); Mitsuo SASAKI, Chigasaki (JP)

(73) Assignee: KABUSHIKI KAISHA TOSHIBA, Minato-ku (JP)

(21) Appl. No.: 16/988,959

(22) Filed: Aug. 10, 2020

(30) Foreign Application Priority Data
Sep. 13, 2019 (JP) 2019-167221

(51) Int. Cl. B23K 26/144; B23K 26/14; B23K 26/342; B23K 26/60

(52) U.S. Cl. CPC B23K 26/144; B23K 26/1464; B23K 2103/02; B23K 26/60; B23K 26/342

(57) ABSTRACT

According to one embodiment, a coating method includes: forming a plurality of recesses in a surface of a member containing a first material; and filling up the recesses and covering at least a part of the surface with solidified powder by supplying powder containing a second material different from the first material. The supplying the powder includes: discharging the powder toward one of the recesses; and melting the powder at a location spaced from an inner surface of the member forming the recess or on the inner surface.

### CROSS-REFERENCE TO RELATED APPLICATIONS

This application is based upon and claims the benefit of priority from Japanese Patent Application No. 2019-167221, filed on Sep. 13, 2019, the entire contents of which are incorporated herein by reference.

### FIELD

Embodiments described herein relate generally to a coating method and a coating structure.

### BACKGROUND

A structure including a member with a surface coated with a material different from the rest of the member is known. For example, objects including a member and a coating material covering the surface of the member are manufactured by various methods such as laser metal deposition.

In the coating process, the material of a member and the material of a coating material may be mixed together. This may exert an unintended influence, such as a decrease in the strength of the mixed portion, depending on the mixing ratio of the two materials.

### BRIEF DESCRIPTION OF THE DRAWINGS

FIG. 1 schematically illustrates an additive manufacturing apparatus according to a first embodiment;

FIG. 2 illustrates a cross-section of a nozzle that performs operation in the first embodiment;

FIG. 3 schematically illustrates a cross-section of an object coated by the additive manufacturing apparatus in the first embodiment;

FIG. 4 schematically illustrates a perspective view of the object during coating in the first embodiment;

FIG. 5 schematically illustrates a cross-section of a part of the object in the first embodiment;

FIG. 6 schematically illustrates a cross-section of a member provided with recesses in the first embodiment;

FIG. 7 schematically illustrates a cross-section of a member according to a second embodiment; and

FIG. 8 schematically illustrates a cross-section of a member according to a third embodiment.

### DETAILED DESCRIPTION

According to one embodiment, a coating method includes: forming a plurality of recesses in a surface of a member containing a first material; and feeding powder to the surface to fill the recesses and cover at least a part of the surface, the powder containing a second material different from the first material and being solidified. The feeding the powder includes: discharging the powder to one of the recesses; and melting and solidifying the powder on an inner surface of the member or at a location apart from the inner surface, the inner surface forming the recesses.

### First Embodiment

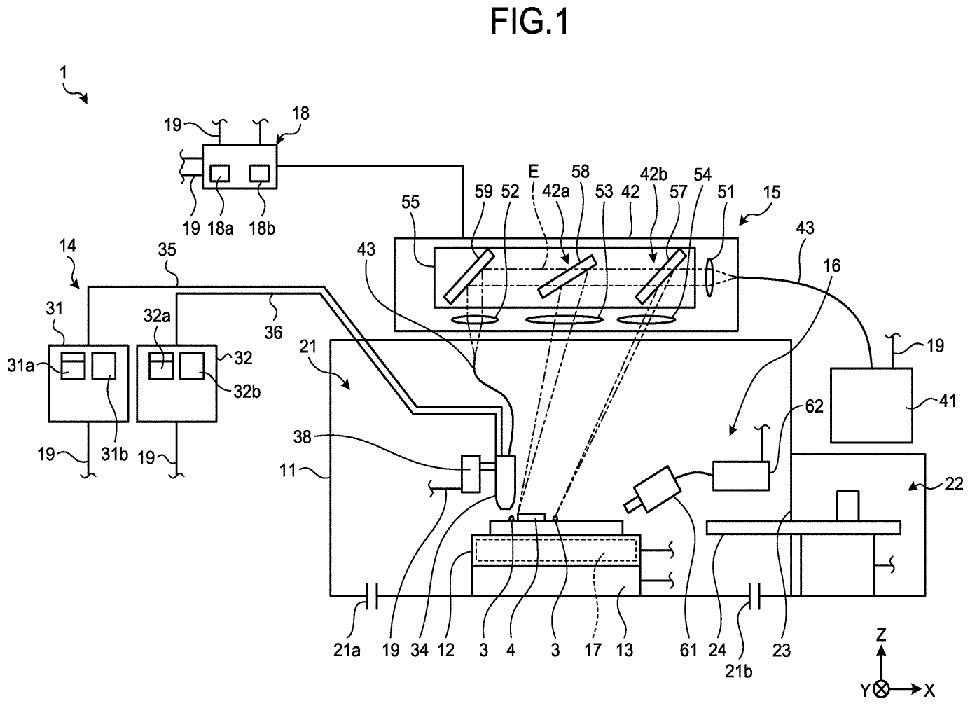

Hereinafter, a first embodiment will be described with reference to FIG. 1 to FIG. 6. In the present specification, a vertical upward direction and a vertical downward direction are defined basically as an upward direction and a downward direction. In the present specification, constituent elements in embodiments may be represented by different expressions and be given different explanations. Such constituent elements and their descriptions are presented for illustrative purpose only and are not intended to limit the scope of the present invention. Constituent elements can also be identified by different names from those used in the present specification. Moreover, constituent elements can be described in different terms from the terms used herein.

FIG. 1 schematically illustrates an additive manufacturing apparatus 1 in the first embodiment. The additive manufacturing apparatus 1 may also be referred to as, for example, a processing apparatus or a treatment apparatus. The additive manufacturing apparatus 1 of the first embodiment serves as a laser-material-deposition, three-dimensional printer. The additive manufacturing apparatus 1 is not limited to this example.

As illustrated in the drawings, an X-axis, a Y-axis, and a Z-axis are defined for the sake of convenience in the present specification. The X-axis, the Y-axis, and the Z-axis are orthogonal to one another. The X-axis and the Y-axis are horizontal. The Z-axis is vertical.

Furthermore, in the present specification, an X direction, a Y direction, and a Z direction are defined. The X direction is along the X-axis, and includes a +X direction indicated by the arrow X and a −X direction opposite to the arrow X. The Y direction is along the Y-axis, and includes a +Y direction indicated by the arrow Y and a −Y direction opposite to the arrow Y. The Z direction is along the Z-axis, and includes a +Z direction (upward) indicated by the arrow Z and a −Z direction (downward) opposite to the arrow Z.

The additive manufacturing apparatus 1 is capable of additively manufacturing an object 4 having a given shape, for example, by adding a layer upon a layer of powder 3. The powder 3 may also be called a powdered material. As illustrated in FIG. 1, the additive manufacturing apparatus 1 includes a treatment tank 11, a stage 12, a moving device 13, a nozzle device 14, an optical device 15, a measuring device 16, a heater 17, a controller 18, and a plurality of signal lines 19.

The additive manufacturing apparatus 1 is capable of additively manufacturing the object 4 from two types of the powder 3. The additive manufacturing apparatus 1 may create the object 4 from one or three or more types of the powder 3.

The treatment tank 11 includes a main chamber 21 and an auxiliary chamber 22. Inside the main chamber 21, the stage 12, the moving device 13, a part of the nozzle device 14, the measuring device 16, and the heater 17 are disposed. The auxiliary chamber 22 is adjacent to the main chamber 21.

A door 23 stands between the main chamber 21 and the auxiliary chamber 22. With the door 23 opened, the main chamber 21 communicates with the auxiliary chamber 22. With the door 23 closed, the main chamber 21 is isolated from the auxiliary chamber 22. With the door 23 closed, the main chamber 21 may be sealed in an airtight manner.

The main chamber 21 is provided with an air inlet 21a and an air outlet 21b. For example, an air supplier is located outside the treatment tank 11 to supply an inert gas, such as nitrogen or argon, into the main chamber 21 via the air inlet 21a. For example, an air exhauster is located outside the treatment tank 11 to discharge gas from the main chamber 21 via the air outlet 21b.

A conveyor 24 extends from the main chamber 21 to the auxiliary chamber 22. The conveyor 24 works to transport the object 4 having been processed from the main chamber 21 to the auxiliary chamber 22. That is, the auxiliary chamber 22 accommodates the object 4 after processed in the main chamber 21.

The stage 12 serves to support the object 4. The moving device 13 works to move the stage 12, for example, in the three axial directions orthogonal to one another. the moving device 13 may rotate the stage 12 about two axes orthogonal to each other.

The nozzle device 14 feeds the powder 3 to the object 4 or the base of the object 4 set on the stage 12. The nozzle device 14 irradiates the fed powder 3 and the object 4 set on the stage 12 with an energy beam E. In the present embodiment, the energy beam E is exemplified by a laser beam.

The nozzle device 14 is capable of concurrently feeding two or more types of the powder 3 and selectively feeding one of the two or more types of the powder 3. The nozzle device 14 emits the energy beam E concurrently with feeding the powder 3. The nozzle device 14 may emit a different energy beam E in addition to the laser beam. The energy beam may be any beam such as an electron beam, a microwave, or an electromagnetic wave in the ultraviolet range as long as it can melt or sinter the powder 3 as the laser beam.

The nozzle device 14 includes a first material feeder 31, a second material feeder 32, a nozzle 34, a first feed pipe 35, a second feed pipe 36, and a moving mechanism 38. The nozzle 34 and the moving mechanism 38 are disposed in the main chamber 21.

The first material feeder 31 includes a tank 31a and a feed unit 31b. The tank 31a stores the powder 3. The feed unit 31b feeds the powder 3 by a carrier gas from the tank 31a to the nozzle 34 via the first feed pipe 35. The carrier gas represents an inert gas, such as nitrogen or argon.

The second material feeder 32 includes a tank 32a and a feed unit 32b. The tank 32a stores a different type of powder 3 from the powder 3 stored in the tank 31a. The feed unit 32b feeds the powder 3 by the carrier gas from the tank 32a to the nozzle 34 via the second feed pipe 36.

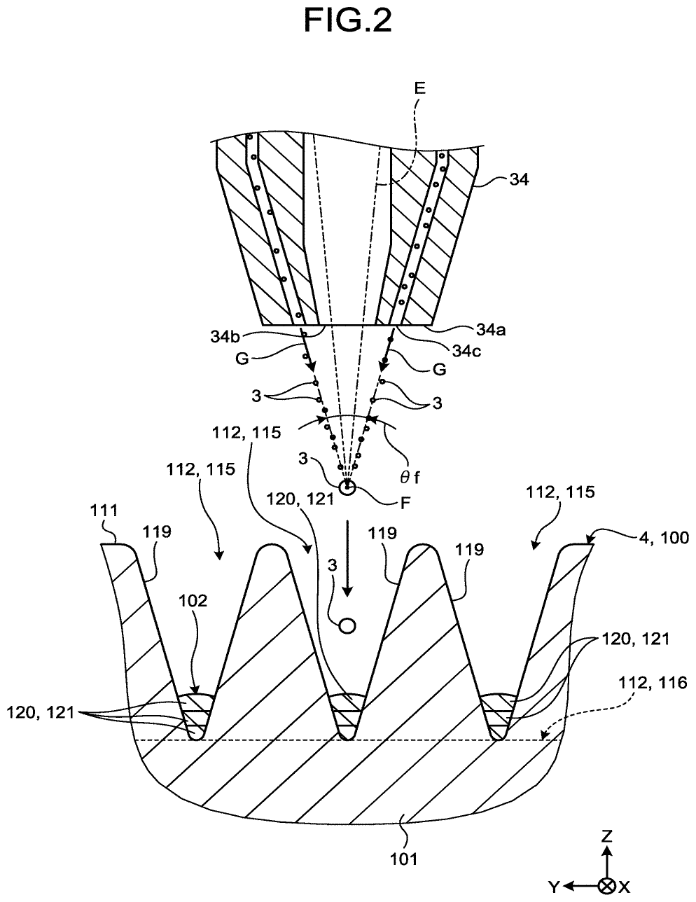

FIG. 2 illustrates a cross-section of the nozzle 34 that performs operation in the first embodiment. As illustrated in FIG. 2, the nozzle 34 has an approximately tubular shape. A tip 34a of the nozzle 34 is directed to the stage 12 and the object 4 set on the stage 12. The nozzle 34 is provided with a beam outlet 34b and a powder outlet 34c.

The beam outlet 34b is located at the tip 34a of the nozzle 34 and is an approximately circular hole. The energy beam E is emitted from the beam outlet 34b. The powder outlet 34c is located at the tip 34a of the nozzle 34 and is an approximately annular hole surrounding the beam outlet 34b. The powder outlet 34c is connected to the first feed pipe 35 and the second feed pipe 36. The powder 3 is discharged from the powder outlet 34c together with a carrier gas G.

The moving mechanism 38 illustrated in FIG. 1 serves to move the nozzle 34 in the three axial directions orthogonal to one another. The moving mechanism 38 may rotate the nozzle 34 about two axes orthogonal to each other. The moving device 13 and the moving mechanism 38 work to move the nozzle 34 relative to the stage 12.

The optical device 15 includes an emitter 41, an optical system 42, and a plurality of cables 43. The emitter 41 includes a light source such as an oscillation element. The emitter 41 emits the energy beam E by the oscillation of the oscillation element. The emitter 41 is capable of changing the output and the focal diameter of the energy beam E to emit.

The emitter 41 is connected to the optical system 42 via the cable 43 such as a hollow fiber. The emitter 41 emits the energy beam E from the oscillation element into the optical system 42 via the cable 43. The energy beam E enters the nozzle 34 via the optical system 42. The optical system 42 serves to irradiate the powder 3 or the object 4, through the nozzle 34, with the energy beam E emitted from the emitter 41.

The optical system 42 includes, for example, a first lens 51, a second lens 52, a third lens 53, a fourth lens 54, and a galvanometer scanner 55. The first lens 51, the second lens 52, the third lens 53, and the fourth lens 54 are stationary. The first lens 51, the second lens 52, the third lens 53, and the fourth lens 54 may be movable biaxially intersecting with or orthogonal to the optical path, for example.

The first lens 51 serves as a collimator lens, for example. The first lens 51 converts the energy beam E, incident on the optical system 42 via the cable 43, into parallel rays. The energy beam E after the conversion enters the galvanometer scanner 55.

The second lens 52 serves to converge the energy beam E emitted from the galvanometer scanner 55. The energy beam E converged on the second lens 52 reaches the nozzle 34 via the cable 43.

Each of the third lens 53 and the fourth lens 54 serves to converge the energy beam E emitted from the galvanometer scanner 55. The object 4 is, for example, irradiated with the energy beam E after converged by the third lens 53 and the fourth lens 54.

The galvanometer scanner 55 serves to split the parallel rays resulting from the conversion by the first lens 51, into rays to enter the second lens 52, the third lens 53, and the fourth lens 54. The galvanometer scanner 55 includes a first galvanometer mirror 57, a second galvanometer mirror 58, and a third galvanometer mirror 59. Each of the first to third galvanometer mirrors 57, 58, and 59 can split light and change an angle of inclination or an output angle.

The first galvanometer mirror 57 allows a part of the energy beam E having passed through the first lens 51 to pass therethrough and reach the second galvanometer mirror 58. Furthermore, the first galvanometer mirror 57 reflects another part of the energy beam E to the fourth lens 54. The first galvanometer mirror 57 changes the irradiation position of the energy beam E having passed through the fourth lens 54 in accordance with the angle of inclination of the first galvanometer mirror 57.

The second galvanometer mirror 58 reflects the part of the energy beam E having passed through the first galvanometer mirror 57 to the third galvanometer mirror 59. Furthermore, the second galvanometer mirror 58 reflects another part of the energy beam E to the third lens 53. The second galvanometer mirror 58 changes the irradiation position of the energy beam E having passed through the third lens 53 in accordance with the angle of inclination of the second galvanometer mirror 58.

The third galvanometer mirror 59 reflects the part of the energy beam E having passed through the second galvanometer mirror 58 to the second lens 52.

The optical system 42 includes a melting device 42a including the first galvanometer mirror 57, the second galvanometer mirror 58, and the third lens 53. The melting device 42a forms layers of the powder 3 and performs annealing treatment thereto by irradiating and heating, with the energy beam E, the powder 3 fed to the object 4 from the nozzle 34.

The optical system 42 further includes a removal device 42b including the first galvanometer mirror 57 and the fourth lens 54. The removal device 42b serves to irradiate the object 4 with the energy beam E to remove an unnecessary portion.

The measuring device 16 measures the shape of a layer of the powder 3 and the shape of the object 4. The measuring device 16 transmits information on the measured shapes to the controller 18. The measuring device 16 includes, for example, a camera 61 and an image processor 62. The image processor 62 performs image processing based on the measurement information from the camera 61. The measuring device 16 is capable of measuring the layer shape of the powder 3 and the shape of the object 4 by interference or optical cutting, for example.

The stage 12 is provided with the heater 17. The heater 17 represents, for example, an electric heater. The heater 17 is capable of heating the object 4 set on the stage 12 to a desired temperature.

The controller 18 is electrically connected to the moving device 13, the heater 17, the first material feeder 31, the second material feeder 32, the emitter 41, the galvanometer scanner 55, and the image processor 62 via the signal lines 19.

The controller 18 includes, for example, a control unit 18a such as CPU, a storage 18b such as ROM, RAM, and HDD, and other various devices. The CPU serves to execute a computer program installed in the ROM or the HDD, to control the respective elements and units of the additive manufacturing apparatus 1.

The storage 18b stores, for example, data representing the shape of the object 4 to create. The storage 18b stores data representing the heights of the nozzle 34 and the stage 12 at every three-dimensional processing position or point. The control unit 18a controls the units of the additive manufacturing apparatus 1 based on such data, enabling the additive manufacturing apparatus 1 to manufacture the object 4.

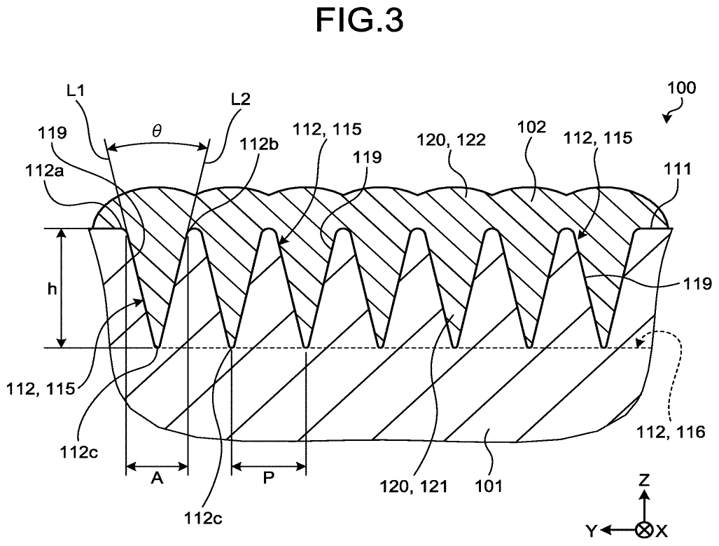

FIG. 3 schematically illustrates a cross-section of an object 100 coated by the additive manufacturing apparatus 1 of the first embodiment. The object 100 includes a member 101 and a coating material 102. The additive manufacturing apparatus 1 can not only additively manufacture the object 4 but also coat the member 101 with the coating material 102.

The member 101 represents an object made of a material containing iron, for example. Iron is an example of a first material. Hereinafter, the material of the member 101 will be called an iron-based material. Examples of the iron-based material includes Alloy 450. The member 101 may contain other materials.

The member 101 is exemplified by a turbine blade. In order to prevent the member 101 from being worn out, the member 101 is coated with the coating material 102. The member 101 is not limited to this example. The member 101 may be the object 4 additively manufactured by the additive manufacturing apparatus 1, or may be manufactured by cutting, casting, forging, or other methods.

The member 101 has a surface 111. In the present embodiment, the surface 111 is an approximately flat surface facing the +Z direction. The surface 111 may be a curved surface, and may face another direction.

The surface 111 of the member 101 is provided with a plurality of recesses 112. The recesses 112 are recessed from the surface 111 approximately in the −Z direction. The Z direction including the −Z direction is an example of a third direction. In the first embodiment the recesses 112 include a plurality of first grooves 115 and a plurality of second grooves 116.

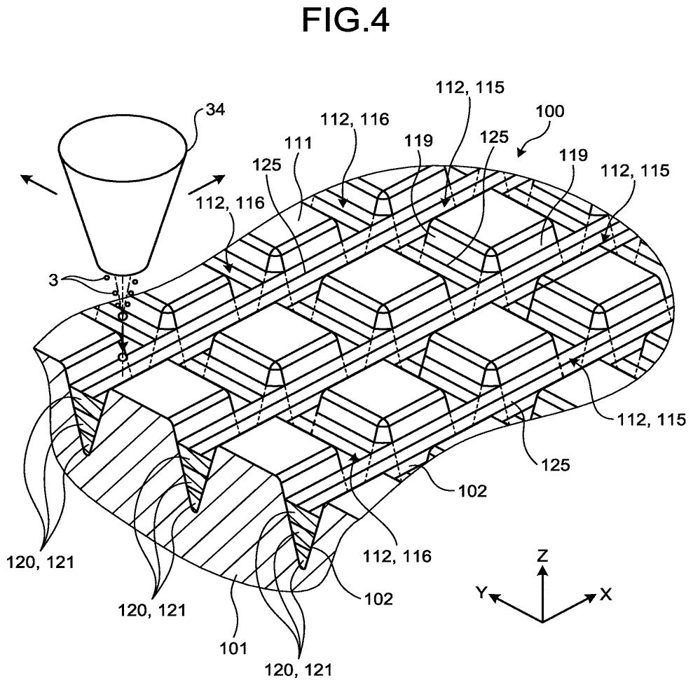

FIG. 4 schematically illustrates a perspective view of the object 100 during coating in the first embodiment. For the sake of better understanding, FIG. 4 depicts the recesses 112 with wider spacing than the other drawings. FIG. 4 partially illustrates a cross section of the object 100. As illustrated in FIG. 4, the first grooves 115 are recessed from the surface 111 approximately in the −Z direction, and extend in the X direction. The X direction is along the surface 111, and is an example of a first direction. The first grooves 115 are spaced from each other in the Y direction. The first grooves 115 extend approximately in parallel.

The second grooves 116 are recessed from the surface 111 approximately in the −Z direction, and extend in the Y direction. The Y direction is along the surface 111 and intersects the X direction, and is an example of a second direction. Thus, the recesses 112 extend along the surface 111. The second grooves 116 are spaced from each other in the X direction. The second grooves 116 extend approximately in parallel.

The second grooves 116 and the first grooves 115 intersect each other. In other words, the first grooves 115 and the second grooves 116 are disposed in a lattice form. The first grooves 115 and the second grooves 116 may be apart from each other.

In the present embodiment the recesses 112 are grooves (the first grooves 115 and the second groove 116) each having a bottom and an approximately triangular cross-section. The recesses 112 are not limited to grooves, and may be another type of recess, such as holes. In the present embodiment, the recesses 112 have approximately the same cross section. However, the recesses 112 may have different cross sections.

To be provided with the recesses 112, the member 101 further includes an inner surface 119 forming or defining the recesses 112. The inner surface 119 is continuous with the surface 111. There may be another part lying between the inner surface 119 and the surface 111.

FIG. 3 illustrates a cross section of the recesses 112 along a normal line to the surface 111. In other words, FIG. 3 illustrates a cross section of the recesses 112 orthogonal to the surface 111. In the cross section, a width A, a minimum angle θ, a depth h, and a pitch P of the recesses 112 are defined.

The width A represents the maximum width of one recess 112 in the cross section of the recesses 112 along the normal line to the surface 111. In other words, the width A represents a distance between a first edge 112a and a second edge 112b of the recess 112 in the cross section. The first edge 112a serves as one boundary between the surface 111 and the inner surface 119 in the cross section. The second edge 112b serves as the other boundary between the surface 111 and the inner surface 119 in the cross section. The first edge 112a and the second edge 112b are apart from each other across the recess 112.

The minimum angle θ represents a minimum of angles between a first line L1 connecting a bottom 112c of the recess 112 and the first edge 112a and a second line L2 connecting the bottom 112c and the second edge 112b. The bottom 112c is part of the recess 112 (the inner surface 119), and farthest from the surface 111. The first line L1 and the second line L2 are virtual lines.

When the bottom 112c of the recess 112 is approximately parallel to the surface 111, for example, the first line L1 and the second line L2 passing through two or more locations on the bottom 112c are assumed. In this case, two or more angles between the first line L1 and the second line L2 are assumed. The minimum angle θ is a minimum angle among the assumed angles.

The depth h represents a distance between the surface 111 and the bottom 112c of the recess 112 in the Z direction orthogonal to the surface 111. In other words, the depth h represents a maximum depth of the recess 112 along the normal line to the surface 111. In the present embodiment, the depth h is set to 200 μm, for example. The depth h is not limited to such an example.

The pitch P represents an interval between two adjacent recesses 112. Specifically, the pitch P represents a distance between the bottom 112c of one of the two adjacent recesses 112 and the bottom 112c of the other one of the two adjacent recesses 112. The pitch P may be a distance between a width-center of one of the two adjacent recesses 112 and a width-center of the other one of the two adjacent recesses 112. The width direction is along the surface 111 in the cross section of the recess 112 along the normal line to the surface 111.

In the present embodiment, a relationship among the width A, the minimum angle θ, and the depth h of the recess 112 can be found by the following Expression 1:

θ=2×a tan(A/2h)>π/4. (Expression 1)

The relationship among the width A, the minimum angle θ, and the depth h is not limited to the one given by Expression 1.

In the present embodiment, a relationship among the pitch P, the minimum angle θ, and the depth h of the recess 112 can be found by the following Expression 2:

θ=2×a tan(P/2h)>π/4. (Expression 2)

The relationship among the pitch P, the minimum angle θ, and the depth h is not limited to the one given by Expression 2.

The pitch P is set to five times or more as large as the average particle diameter of the powder 3. In the present embodiment, for example, the average particle diameter of the powder 3 is set to 30 μm, and the pitch P is set to 300 μm. The particle diameter of the powder 3 and the pitch P are not limited to such examples.

The additive manufacturing apparatus 1 adds a layer upon a layer of the powder 3 to the member 101 to form the coating material 102. In other words, the additive manufacturing apparatus 1 adds layers of the coating material 102 on the member 101. The coating material 102 is made of the powder 3.

The powder 3 and the coating material 102 are made from a material containing cobalt alloy, for example. Cobalt alloy is an example of a second material. Hereinafter, the material of the powder 3 and the coating material 102 will be called a cobalt-based material. Examples of the cobalt-based material include Stellite6 (registered trademark). The powder 3 and the coating material 102 may contain other materials.

The material of the member 101, i.e., iron-based material and the material of the powder 3 and the coating material 102, i.e., cobalt-based material are different from each other. However, the member 101, the powder 3, and the coating material 102 may partially contain the same material. For example, the cobalt-based material may contain iron, and the iron-based material may contain cobalt. Alternatively, both the iron-based material and the cobalt-based material may contain another substance such as chromium.

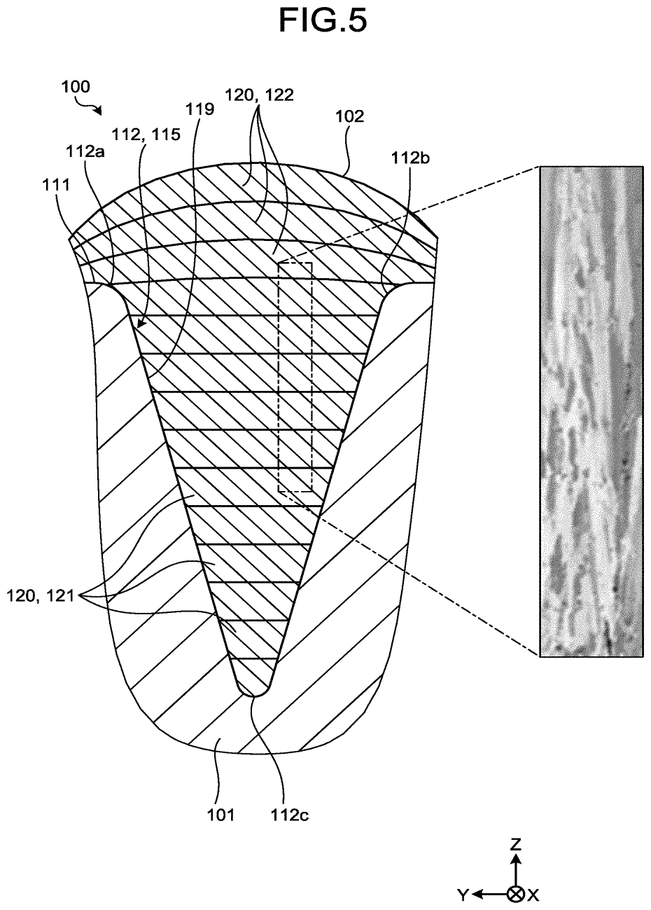

FIG. 5 schematically illustrates a cross-section of a part of the object 100 of the first embodiment. As illustrated in FIG. 5, the coating material 102 includes added layers 120 of the powder 3. For example, the powder 3 is discharged from the nozzle 34 and melted by the energy beam E emitted from the nozzle 34. The molten powder 3 then solidifies, forming the layers 120.

Each of the layers 120 spreads approximately flat on an X-Y plane. The layers 120 may be uneven. The layers 120 are laminated approximately in the Z direction. The layers 120 include a plurality of first layers 121 and a plurality of second layers 122.

The first layers 121 are laminated in the Z direction (the −Z direction) inside the recesses 112. In other words, the first layers 121 are accommodated in the recesses 112. The first layers 121 may be partially located outside the recesses 112. The first layers 121 attach or adhere to the inner surface 119 forming the recesses 112.

The second layers 122 are laminated in the Z direction (the −Z direction) outside the recesses 112. The second layers 122 may be partially located inside the recesses 112. The second layers 122 cover at least a part of the surface 111. The second layers 122 further cover the first layers 121.

As described above, the recesses 112 are filled with the coating material 102. Furthermore, the coating material 102 (the first layers 121) inside the recesses 112 is mutually connected via a part of the coating material 102 (the second layers 122) covering the surface 111.

The coating material 102 has higher wear resistance than the member 101, for example. Thus, covering the surface 111 of the member 101 by the coating material 102 can enhance the wear resistance of the object 100. Furthermore, filling the recesses 112 of the member 101 with the coating material 102 enables the coating material 102 to firmly attach to the member 101 by anchor effect, leading to enhancing the strength of the object 100.

Hereinafter, a manufacturing method of the object 100 will be partially illustrated. The manufacturing method of the object 100 is not limited to the following method, and other methods may be applied. First, the member 101 is manufactured. Next, the member 101 before the recesses 112 are formed therein is disposed on the stage 12 of the additive manufacturing apparatus 1.

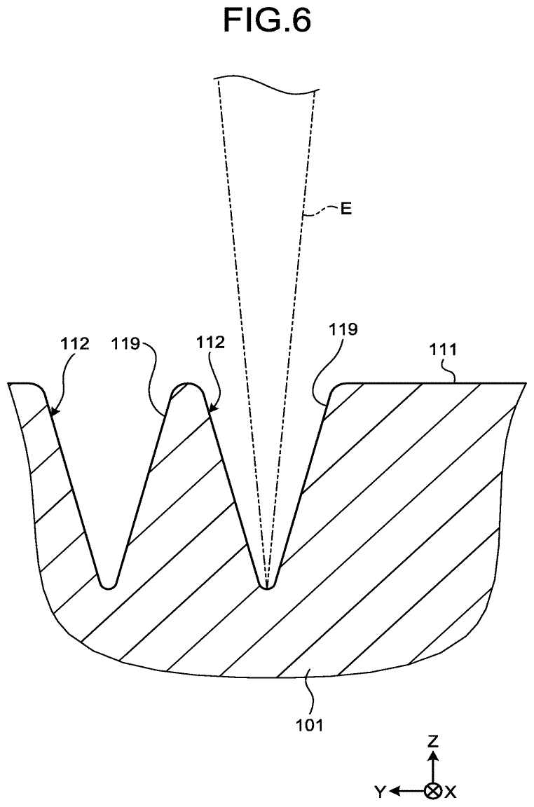

FIG. 6 schematically illustrates a cross-section of the member 101 having the recesses 112 formed therein in the first embodiment. Next, as illustrated in FIG. 6, the recesses 112 are formed in the surface 111 of the member 101.

For example, the removal device 42b of the additive manufacturing apparatus 1 irradiates the surface 111 with the energy beam E to evaporate a part of the member 101. The energy beam E scans the surface 111, thereby forming the recesses 112 in the surface 111. The emitter 41 sets a higher output of the energy beam E with which the surface 111 is irradiated, and sets a smaller focal diameter of the energy beam E.

The recesses 112 may be formed by other methods. For example, the recesses 112 may be formed in the surface 111 by various types of machining, such as cutting with a tool as a twist drill or a milling cutter, or pressing using a die.

The member 101 provided with the recesses 112 may be manufactured. For example, the additive manufacturing apparatus 1 may additively manufacture the member 101 provided with the recesses 112. Alternatively, the member 101 provided with the recesses 112 may be manufactured by casting or pressing. That is, the recesses 112 may be formed in the surface 111 after or concurrently with the manufacturing of the member 101.

Next, the heater 17 in FIG. 1 heats the member 101 on the stage 12. Instead of the heater 17, the optical device 15 may irradiate the member 101 with the energy beam E to heat the member 101. The temperature of the member 101 is set at a temperature lower than the melting point of the member 101.

Next, as illustrated in FIG. 2, the nozzle 34 of the nozzle device 14 discharges the powder 3 to one of the recesses 112. For example, the moving device 13 or the moving mechanism 38 moves the nozzle 34 relative to the member 101. The tip 34a of the nozzle 34 is directed to the one of the recesses 112.

For example, the second material feeder 32 feeds the powder 3 of the cobalt-based material to the nozzle 34 by the carrier gas G. The nozzle 34 discharges the powder 3 of the cobalt-based material together with the carrier gas G from the powder outlet 34c to the recess 112. In other words, the powder 3 of the cobalt-based material is discharged to the recess 112 by the carrier gas G jetted to the recess 112. Carried by the carrier gas G or by inertia based on the speed given by the carrier gas G, the powder 3 can enter the recess 112 deeply.

The nozzle 34 discharges the powder 3 of the cobalt-based material from the annular powder outlet 34c to a focus F. The focus F is set to a position spaced from the tip 34a of the nozzle 34 in the −Z direction and from the powder outlet 34c in a horizontal direction (the X direction and/or the Y direction). For example, the nozzle 34 discharges the powder 3 in an approximately conical form from the powder outlet 34c to the focus F. In other words, the nozzle 34 discharges the powder 3 to the focus F in a plurality of directions.

An angle θf of the powder 3 discharged in the approximately conical form is approximately equal to the minimum angle θ of the recess 112. The inner surface 119 of the recess 112 extends in the discharge direction of the powder 3 of the cobalt-based material. In other words, the powder 3 discharged from the nozzle 34 includes the powder 3 discharged along the inner surface 119. The recess 112 and the inner surface 119 are formed in accordance with the discharge direction of the powder 3. The discharge direction of the powder 3 and the extending direction of the inner surface 119 are not limited to the above-mentioned examples.

Next, the powder 3 of the cobalt-based material is melted at a location apart from the inner surface 119. For example, the optical device 15 applies the energy beam E to the nozzle 34. The nozzle 34 emits the energy beam E from the beam outlet 34b. The emitter 41 sets a lower output of the energy beam E to be emitted from the nozzle 34, and sets a larger focal diameter of the energy beam E. The output and the focal diameter of the energy beam E are not limited to such examples.

The focus of the energy beam E approximately coincides with the focus F of the powder 3 to be discharged. Hereinafter, thus, the focus of the energy beam E will be also referred to as the focus F. The powder 3 of the cobalt-based material discharged from the powder outlet 34c converges at the focus F of the energy beam E. Thus, the powder 3 of the cobalt-based material is melted by the energy beam E.

The focus F is set apart from the member 101. Thus, the powder 3 is melted in the air and falls or flies to the recess 112 by force of gravity or inertia. At the focus F, drops of molten powder 3 may fuse together.

The powder 3 of the cobalt-based material attaches to the inner surface 119 forming the recess 112, and is cooled by, for example, heat conduction from the member 101. The cooled powder 3 solidifies to form the layer 120. Due to the heated member 101, the molten powder 3 easily becomes moist and spread over the inner surface 119. The melting device 42a may perform annealing treatment to the formed layer 120.

With at least one layer 120 formed, the powder 3 of the cobalt-based material attaches to the layer 120, and is cooled by, for example, heat conduction between the layer 120 and the member 101. The cooled powder 3 solidifies to form a new layer 120.

As illustrated in the example of FIG. 2, the focus F is apart from the surface 111 of the member 101 in the +Z direction, for example. However, the focus F is not limited to this example, and may be located inside the recess 112. Since the angle θf at which the powder 3 is discharged is approximately equal to the minimum angle θ of the recess 112, the discharged powder 3 is prevented from interfering with the member 101. The moving device 13 and/or the moving mechanism 38 may move the nozzle 34 relative to the member 101 to change the position of the focus F.

The focus F may be set, for example, on the inner surface 119 forming the recess 112 or inside the member 101. In this case, the powder 3 is melted on the inner surface 119. In other words, the powder 3 may be melted while being in contact with the inner surface 119. The powder 3 is melted and attaches to the inner surface 119, and is cooled by, for example, heat conduction from the member 101. The cooled powder 3 solidifies to form the layer 120.

The melting point of the iron-based material is higher than the melting point of the cobalt-based material. Hence, the member 101 is prevented from being melted when the molten powder 3 of the cobalt-based material attaches to the inner surface 119. The temperature of the member 101 is set such that the member 101 is prevented from being melted due to heat conduction from the powder 3. The member 101 may be slightly melted.

After forming the layer 120 in one of the recesses 112, the nozzle 34 discharges the powder 3 to a next one of the recesses 112. The nozzle 34 also emits the energy beam E to melt the powder 3 of the cobalt-based material. The nozzle 34 repeats the formation of the layer 120 in the recesses 112.

Feeding the powder 3 of the cobalt-based material includes discharging and melting the powder 3 of the cobalt-based material. By feeding the powder in such a manner, the first layers 121 are formed, and the recesses 112 are filled with the first layers 121, i.e., solidified powder 3. By feeding the powder 3 of the cobalt-based material, the second layers 122 are formed, and at least a part of the surface 111 of the member 101 is covered with the second layers 122, i.e., solidified powder 3. Through the above-described processes, the coating material 102 is formed, completing the manufacturing of the object 100.

The surface of the coating material 102 may be evenly processed. For example, the removal device 42b irradiates the coating material 102 with the energy beam E to evaporate a part of the coating material 102. Alternatively, the coating material 102 may be partially cut off with a tool such as a milling cutter.

As illustrated in FIG. 4, the nozzle 34 moves with respect to the member 101 in the extending direction of the recess 112. Thus, the recess 112 is filled with the first layers 121 (the solidified powder 3) in the extending direction of the recess 112. This forms a bead mark 125, extending in the extending direction of the recess 112, on the first layer 121. The extending direction of the bead mark 125 is not limited to this example. With no bead mark 125 formed, the powder 3 is melted at a location apart from the recess 112 or on the inner surface 119, and solidifies in the recess 112. Thereby, the recesses 112 can be filled with the first layers 121.

In the manufacturing method of the object 100 as described above, the member 101 is prevented from being melted. That is, the iron-based material of the member 101 and the cobalt-based material of the powder 3 (the coating material 102) are prevented from being mixed together. At the boundary between the member 101 and the coating material 102, for example, the material composition of the object 100 in the Z direction exhibits a higher change rate than 1%/μm.

FIG. 5 illustrates, on the right-hand side, an exemplary crystalline arrangement of a part of the coating material 102 measured by electron back scatter diffraction patterns (EBSD), which corresponds to a partial, schematic cross-sectional diagram of the object 100. In the crystalline arrangement of FIG. 5, crystals having the same orientation are represented by the same color. That is, in the portion of the same color in the crystalline arrangement diagram, crystals having the same orientation are continuously aligned, or single crystals having a given orientation continuously extends.

As illustrated in FIG. 5, by forming the coating material 102 by the above-mentioned method, in the first layers 121 and the second layers 122, the crystals having the same orientation become continuous approximately in the Z direction. In other words, in the coating material 102, crystals aligned approximately in the Z direction have the same orientation, or single crystals having a given orientation extends approximately in the Z direction. The orientation of the crystals can be determined by various methods, such as EBSD method or visual observation.

The orientation of the crystal is affected by the direction in which a molten material is cooled. The molten powder 3 of the cobalt-based material, when attached to the inner surface 119 of the member 101 or the formed layer 120, conducts heat to the member 101 and/or the formed layer 120 approximately in the −Z direction. This allows the cooling directions of the powder 3 (the layer 120) laminated in the Z direction to be substantially uniform, and the crystals having the same orientation to be continuous approximately in the Z direction.

In the present embodiment, in at least the first layers 121, crystals having the same orientation may be continuous approximately in the Z direction. The orientations of the crystals may be not uniform in the entirety of the first layers 121 in the Z direction.

The manufacturing method of the object 100 is not limited to the above-described method. For example, the additive manufacturing apparatus 1 may feed the powder 3 of the iron-based material to the nozzle 34 from the first material feeder 31, and feed the powder 3 of the cobalt-based material to the nozzle 34 from the second material feeder 32. The additive manufacturing apparatus 1 can simultaneously form the member 101 and the coating material 102 by switching between the amount of the powder 3 of the iron-based material and the amount of the powder 3 of the cobalt-based material when discharged from the nozzle 34.

For example, the nozzle 34 additively forms the member 101 by discharging the powder 3 of the iron-based material to a space coordinate system for forming the member 101. The nozzle 34 forms the coating material 102 by discharging the powder 3 of the cobalt-based material to a space coordinate system for forming the coating material 102.

In this case, the recesses 112 in the member 101 and the coating material 102 are approximately simultaneously formed. By laminating layers of the member 101 provided with the recesses 112, for example, the recesses 112 are formed in the surface 111 of the member 101. At the same time, the powder 3 of the cobalt-based material is discharged from the nozzle 34 to the formed recess 112 or to a location at which the recess 112 is to be formed later. The powder 3 of the cobalt-based material is melted at a location apart from the inner surface 119 or a location at which the inner surface 119 is to be formed, or on the inner surface 119. By feeding the powder 3 of the cobalt-based material in this manner, the object 100 having the recesses 112 filled with the solidified powder 3 and the surface 111 at least partially covered with the solidified powder 3 is additively manufactured.

In the first embodiment described above, the recesses 112 are formed in the surface 111 of the member 101. By feeding the powder 3, the recesses 112 are filled with and at least a part of the surface 111 is covered with the solidified powder 3. The feeding powder 3 includes: discharging the powder 3 to each one of the recesses 112; and melting the powder 3 at a location apart from the inner surface 119 of the member 101 forming the recess 112, or on the inner surface 119. Thereby, the recesses 112 are filled with a part of the layer 120 of the cobalt-based material formed of the molten and solidified powder 3, and the layer 120 can firmly attach to the member 101 by anchor effect. Furthermore, the powder 3 is melted before attached to the inner surface 119 of the recess 112, so that the member 101 is prevented from being melted by the means for melting the powder 3. This can avoid the cobalt-based material contained in the powder 3 and the iron-based material contained in the member 101 from being mixed together. In other words, the mixing of the cobalt-based material contained in the powder 3 and the iron-based material contained in the member 101 is prevented or reduced. Thus, the iron-based material and the cobalt-based material are avoided from being mixed at a certain mixing ratio at which the iron-based material and the cobalt-based material become fragile, lowering decrease in the strength of the object 100 containing the iron-based material and the cobalt-based material.

Typically, a mixture of an iron-based material and a cobalt-based material may become fragile when mixed at a certain ratio. Thus, such a mixed material may be cracked or the connection between the iron-based material and the cobalt-based material may decrease in strength. In contrast, in the present embodiment, the cobalt-based material contained in the powder 3 and the iron-based material contained in the member 101 are prevented from being mixed together. Thus, it is possible to prevent occurrence of cracks and a decrease in strength at the boundary between the member 101 and the coating material 102.

The powder 3 is melted by the energy beam E. The focus F of the energy beam E is set apart from the member 101. Thus, the member 101 is prevented from being melted by the energy beam E. This can avoid the iron-based material and the cobalt-based material from being mixed together at a certain mixing ratio at which the iron-based material and the cobalt-based material become fragile, reducing a decrease in the strength of the object 100.

The inner surface 119 extends in the discharge direction of the powder 3. This makes it easier for the powder 3 to enter the recesses 112 deeply, resulting in avoiding the occurrence of a void in the recesses 112 filled with the powder 3.

Along the normal line to the surface 111, the recess 112 has a cross section that satisfies the expression:

θ=2×a tan(A/2h)>π/4

where A represents the width of the recess 112; θ represents the minimum angle between the first line L1 connecting the bottom 112c of the recess 112 and the first edge 112a of the recess 112 and the second line L2 connecting the bottom 112c of the recess 112 and the second edge 112b of the recess 112; and h represents the depth of the recess 112 along the normal line to the surface 111. Thus, the molten powder 3 is less hindered from deeply entering the recess 112 due to, for example, a surface tension. That is, the powder 3 can easily enter the recess 112 deeply, preventing the occurrence of a void in the recess 112 filled with the powder 3.

The recesses 112 include at least one first groove 115 extending in the X direction along the surface 111; and at least one second groove 116 extending in the Y direction and intersecting the first groove 115. The Y direction is along the surface 111 and intersects the X direction. Such recesses serve to enhance the anchor effect and allow the layer 120 of the cobalt-based material to firmly attach to the member 101. Furthermore, at the intersection between the first groove 115 and the second groove 116, the molten powder 3 can flow into both the first groove 115 and the second groove 116. That is, the layer 120 of the cobalt-based material can be flattened at the intersection between the first groove 115 and the second groove 116.

The member 101 is heated. This leads to improving the wettability of the molten powder 3 on the inner surface 119. That is, the molten powder 3 more easily enters the recess 112 deeply, reducing the occurrence of a void in the recess 112 filled with the powder 3.

The melting point of the iron-based material of the member 101 is higher than the melting point of the cobalt-based material of the coating material 102. Thus, the member 101 is prevented from being melted by the means for melting the powder 3. This serves to avoid the iron-based material and the cobalt-based material from being mixed at a certain mixing ratio at which the iron-based material and the cobalt-based material become fragile, preventing the object 100 from lowering in strength.

The recesses 112 are filled with the solidified powder 3 in the extending direction of the recesses 112. Thereby, the layer 120 of the cobalt-based material can be more firmly attached to the member 101. Furthermore, the movement path of the nozzle 34 is simplified, resulting in reducing processing time taken for forming the layer 120 of the cobalt-based material.

The powder 3 is discharged to one of the recesses 112 by the carrier gas G jetted to the one of the recesses 112. Thus, the powder 3 can easily enter the recess 112 deeply, preventing the occurrence of a void in the recess 112 filled with the powder 3.

The coating material 102 includes the first layers 121 laminated in the Z direction and accommodated in the recesses 112 to attach to the inner surface 119; and the second layers 122 laminated in the Z direction and covering at least a part of the surface 111. In at least the first layers 121 of the coating material 102, crystals having the same orientation are continuous in the Z direction. Such crystals are referred to columnar crystals. The crystals may be single crystals. Thus, the coating material 102 increases in tensile strength in the Z direction and becomes firmly attachable to the member 101. In the case of the object 100 serving as a turbine blade, for example, the coating material 102 may receive a force in a direction (i.e., direction of tensile) away from the member 101. In the coating material 102, the orientations of the crystals are the same, as described above, which leads to enhancing the strength of the object 100 against such a force.

### Second Embodiment

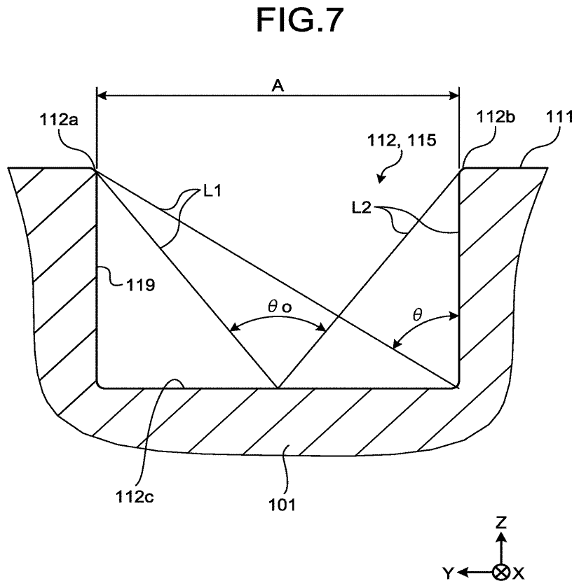

Hereinafter, a second embodiment will be described with reference to FIG. 7. In a plurality of embodiments below, constituent elements with functions similar to the functions of the already-described elements, are denoted by the same reference numerals therefor and description thereof may be omitted. Constituent elements denoted by the same reference numerals may not have all the functions and properties in common, and may have different functions and properties depending on the respective embodiments.

FIG. 7 schematically illustrates a cross-section of the member 101 in the second embodiment. As illustrated in FIG. 7, the recess 112 of the second embodiment has an approximately rectangular cross section. Thus, the bottom 112c of the recess 112 is approximately parallel to the surface 111.

In the second embodiment, first lines L1 and second lines L2 passing through a plurality of locations on the bottom 112c are assumed. In this case, two or more angles between the first lines L1 and the second lines L2, including the minimum angle θ and another angle θo, are assumed. The minimum angle θ is defined as the minimum angle among the assumed angles.

In the second embodiment, the nozzle 34 discharges the powder 3 in the Z direction, for example, from a powder outlet of an approximately circular form. Thus, also in the second embodiment, the inner surface 119 extends in the discharge direction of the powder 3. The discharge direction of the powder 3 is not limited to this example.

### Third Embodiment

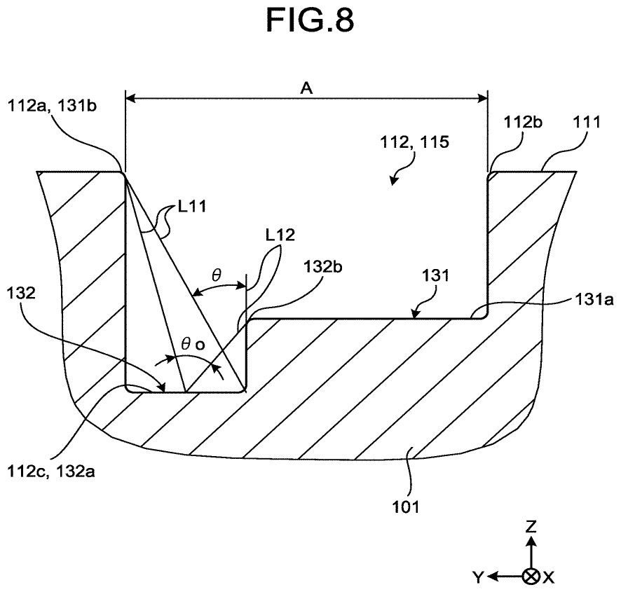

Hereinafter, a third embodiment will be described with reference to FIG. 8. FIG. 8 schematically illustrates a cross-section of the member 101 in the third embodiment. As illustrated in FIG. 8, each of the recesses 112 of the third embodiment is a stepped recess and includes a first recess 131 and a second recess 132.

The second recess 132 is recessed in the −Z direction from a bottom 131a of the first recess 131. That is, the bottom 131a of the first recess 131 is apart from a bottom 132a of the second recess 132 in the +Z direction. The bottom 132a of the second recess 132 coincides with the bottom 112c of the entirety of the recess 112.

In the third embodiment, the minimum angle θ represents a minimum of the angles between two lines, one connecting the bottom 112c of the recess 112 and an edge of the second recess 132 and the other connecting the bottom 112c and an edge of the first recess 131, the edge being visible from the bottom 112c. In the example of FIG. 8, the minimum angle θ is a minimum of the angles between first lines L11 connecting the bottom 112c of the recess 112 and an edge 131b of the first recess 131 and second lines L12 connecting the bottom 112c and an edge 132b of the second recess 132. The first lines L11 and the second lines L12 are virtual lines.

In the third embodiment, the bottom 112c of the recess 112 is approximately parallel to the surface 111. In this case, the first lines L11 and the second lines L12 passing through a plurality of locations on the bottom 112c are assumed. In this case, two or more angles between the first lines L11 and the second lines L12, such as the minimum angle θ and another angle θo, are assumed. The minimum angle θ is the minimum angle among the assumed angles.

The first to third embodiments have described the example that the member 101 contains the iron-based material and the coating material 102 contains the cobalt-based material. However, the materials of the member 101 and the coating material 102 are not limited to such examples. For example, the member 101 may contain aluminum, and the coating material 102 may contain iron. Alternatively, the member 101 may contain copper, and the coating material 102 may contain ceramics. As described above, the member 101 and the coating material 102 may contain different materials.

According to at least one of the first to third embodiments described above, a plurality of recesses is formed on the surface of a member. The feed of powder includes discharging the powder to each one of the recesses and melting and solidifying the powder at a location apart from the inner surface of the member, the inner surface forming the recess. By feeding the powder in such a manner, the solidified powder fills the recesses, and covers at least a part of the surface. Thus, the recesses are filled with a part of a layer of a second material formed of the molten and solidified powder, and the layer can firmly attach to the member by anchor effect. Furthermore, the powder is melted before attaching to the inner surface of the recess, which prevents the member from being melted by the means for melting the powder. Thus, the second material contained in the powder and a first material contained in the member are prevented from being mixed together. That is, the first material and the second material are prevented from being mixed at a certain mixing ratio at which the first material and the second material become fragile, preventing a finished product containing the first material and the second material from lowering in strength.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A coating method, comprising:
forming a plurality of recesses in a surface of a member containing a first material; and
feeding powder to the surface to fill the recesses and cover at least a part of the surface, the powder containing a second material different from the first material and being solidified, wherein the feeding the powder includes:
discharging the powder to one of the recesses; and
melting and solidifying the powder on an inner surface of the member or at a location apart from the inner surface, the inner surface forming the recesses.

2. The coating method according to claim 1, wherein
the powder is melted by an energy beam, and
the energy beam focuses on a location apart from the member or on the inner surface.

3. The coating method according to claim 1, wherein the inner surface extends in a direction in which the powder is discharged.

4. The coating method according to claim 1, wherein
along a normal line to the surface, the recesses have a cross section that satisfies the following expression:
θ=2×a tan(A/2h)>π/4
where A represents a width of each recess; θ represents a minimum angle between a first line connecting a bottom and one edge of the recess and a second line connecting the bottom and the other edge of the recess; and h represents a depth of the recess along the normal line to the surface.

5. The coating method according to claim 1, wherein
the recesses include:
at least one first groove extending in a first direction along the surface; and
at least one second groove extending in a second direction and intersecting the first groove, the second direction being along the surface and intersecting the first direction.

6. The coating method according to claim 1, further comprising heating the member.

7. The coating method according to claim 1, wherein
the first material has a higher melting point than the second material.

8. The coating method according to claim 1, wherein
the recesses extend in a direction along the surface, and
the recesses are filled with the solidified powder in the extending direction of the recesses.

9. The coating method according to claim 1, wherein
the powder is discharged to one of the recesses by a carrier gas jetted to the one of the recesses.

10. A coating structure, comprising:
a member
containing a first material, and
including a surface and an inner surface that forms a plurality of recesses recessed in a third direction from the surface; and
a coating material containing a second material, and including:
a plurality of first layers laminated in the third direction and accommodated in the recesses to attach to the inner surface, and
a plurality of second layers laminated in the third direction and covering at least a part of the surface,
wherein, at least in the first layers, crystals having the same orientation are continuous in the third direction.

11. The coating structure according to claim 10, wherein
the crystals are columnar crystals or single crystals.
